(19) United States
(12) Patent Application Publication
(10) Pub. No.: US 2003/0079020 A1
(43) Pub. Date: Apr. 24, 2003

(54) Method, system and service provider for IP media program transfer-and-viewing-on-demand

(76) Inventors: Christophe Gourraud, Montreal (CA); Roch Glitho, Montreal (CA); Stephane Desrochers, Blainville (CA); Kindy Sylla, Montreal (CA)

Correspondence Address: ERICSSON RESEARCH CANADA, 8400 DECARIE BLVD., MONTREAL, QC, H4P 2N2, CA

(21) Appl. No.: 09/682,839

(22) Filed: Oct. 23, 2001

(51) Int. Cl. H04N 7/173; G06F 15/16

(52) U.S. Cl. 709/227; 725/109

(57) ABSTRACT

A method, system, and service provider for program-on-demand service in a telecommunications network, wherein a Session Initiation Protocol (SIP) terminal sends to a service provider, preferably over an HTTP link, a program request for a plurality of selected programs. The service provider determines which content provider stores the first program, and establishes an SIP session between that content provider and the SIP terminal, session which is used for streaming the first selected program to the SIP terminal, preferably using Real-Time Protocol (RTP). At the termination of a first program, the service provider releases the first SIP session and establishes a second SIP session between the SIP terminal and a second content provider storing the second program. The service provider may have a Web Server for selecting programs, and may be connected to an SIP functionality having a Parlay/SIP converter and an SIP server for handling SIP sessions using Parlay/OSA-based messages.

### BACKGROUND OF INVENTION

1. Field of the Invention

The present invention relates to IP networks, and particularly to a method and system for allowing IP media program transfer-and-viewing-on-demand.

2. Description of the Related Art

Program service on demand exists for a number of years. Television programs on demand are available in many areas. Such a typical arrangement can consist of a television set connected through a coaxial cable network to a television programs provider. The viewer can select and order through the terminal a particular program to be viewed. Upon selection of the particular program, the program's data is transferred from the television program provider, through the network, to the user's terminal, where it is displayed for the user. FIG. 1.a is a high-level network diagram illustrating the depicted simple prior art scenario wherein one “pay-per-view” TV set 10 connects (with user intervention) to one pay-per-view TV provider 12 for the selection and view of a given movie by the user.

FIG. 1.B is another high-level network diagram of an analogous scenario wherein, using the Internet 14, an Internet terminal 16 can select a program to be viewed, such as for example a sound file, from an Internet sound file provider 18, such as for example from mp3.com^{R}. For doing so, the Internet user can click on the particular file's URL, and the file is downloaded and executed on the user's terminal 16. Alternatively, the selected file can be streamed in real-time, or in quasi-real-time to the user's terminal 16.

When the end user desires to access a given program of a particular media type, such as for example a pay-per-view movie in an AVI (Audio Video Interleaved) format, or a sound file in MP3 (Moving Picture Experts Group Layer-3 Audio) format, the user must first connect to the particular program provider, and order the requested program. Then, the program is downloaded to the user's terminal where it is viewed or listened. FIG. 2 illustrates a high-level flowchart showing the limited prior art scenario wherein the user first connects to the program provider, action 20, requests the given program, action 22, and then the program is transferred from the provider to the user, action 24.

Typically, according to this prior art implementation, the user can only order programs of one given type from a given program provider, such as for example movies from a movie provider, songs from a sound file provider, etc. Therefore, a drawback of the current implementation is that a user desiring to access a variety of programs must directly connect to a plurality of service providers, oftentimes using different electronic devices. For example, a user desiring to see a movie must first connect through the Internet using his or her PC terminal to download and see the movie preview in AVI or ShockWave™ video formats, and only afterwards can connect through the television set to order and view the particular movie. Even using the same PC-based Internet terminal, a user must directly connect to various providers in order to access different media programs.

To these days, there is no service provider that allows the user to access a diversity of media programs through a single, integrated, and, convivial interface regrouping access to more than just one type of media.

With the widespread development of the Internet, web sites offer an ever-increasing variety of services to the Internet users. New network and business models involving the Internet are also being proposed, wherein some web sites, herein called content providers, tend to be specialized in the provision of information of a specific type or subject, while other sites, herein called service providers, are specialized in gathering information from the content providers and offer it to the end-users. However, this new network and business model is only in the early development stages, and encounters a diversity of challenges, mostly related to the use of proprietary interfaces and protocols by each content provider or service provider. The development and implementation of each such proprietary interface and protocol involves a heavy development and financial burden on the involved companies. Therefore, once implemented, these companies are oftentimes reluctant to perform additional work to adapt their protocol or interface to communicate with other sites.

Even in case an interconnection between a service provider and one or more content providers is achieved, the end-user always downloads selected programs from the content provider through the service provider. As a consequence of this network implementation, a bandwidth bottleneck is created at the level of the service provider in the case wherein many users request significant bandwidth at substantially the same time.

It would be useful to have a network and business model using an industry widely accepted, simple yet effective protocol to intercommunicate between IP-based content providers and service providers for the provision of various types of multimedia content to the end-user. It would be also practical to have a network model that avoids the occurrence of bandwidth bottlenecks at the level of any node of the network, including at the level of the service provider. Furthermore, it would be convenient to provide the end-user with increased flexibility for accessing and viewing, or listening to, the selected programs.

The present invention provides such a solution.

### SUMMARY OF THE INVENTION

It is therefore one broad object of this invention to provide a system for Internet Protocol (IP) media program transfer-and-viewing-on-demand. According to the invented system, a user's terminal is connected to a (media program) service provider through a communication link, such as for example via an Internet HTTP (Hyper Text Transfer Protocol) link. The service provider is in turn connected to one or more content providers via at least a session-based protocol, such as for example the Session Initiation Protocol (SIP), which content providers each comprise at least one given type of media programs, such as for example movies, songs, news, movie previews, etc. According to the invention, the end-user first connects his/her terminal to the service provider, such as for example via the web server of the service provider through the HTTP link, and selects for viewing a given program. The service provider further connects to the content providers server having the movie, via the SIP session. The service provider invites both the terminal and the content provider in an SIP communication session, during which the program file is transferred directly from the content provider to the terminal, and executed on the end-user's terminal.

Accordingly, it an object of the present invention to provide in a telecommunications network comprising a program service provider connected to a plurality of program content provider, a method of performing program-on-demand from a Session Initiation Protocol (SIP) terminal, the method comprising the steps of: a) sending a program request to the service provider, the program request comprising a program list including a plurality of selected programs; b) responsive to a receipt of the program request, determining in the service provider a content provider storing a first program (P1) from the plurality of selected programs; c) the service provider establishing a first SIP session between the SIP terminal and the content provider storing the first program P1; and d) streaming from the content provider storing the first program P1 to the SIP terminal the first program P1 over the first SIP session.

It is another object of the present invention to provide a telecommunications network comprising: an SIP terminal; a program service provider connected to the SIP terminal through a communications interface; a plurality of programs content providers connected to the service provider; wherein the SIP terminal sends to the service provider a program request comprising a program list including a plurality of selected programs, the service provider determines a content provider storing a first program (P1) from the plurality of selected programs and establishes a first SIP session between the SIP terminal and the content provider, the content provider streaming the first program P1 to the SIP terminal over the first SIP session.

It is yet another object of the invention to provide a service provider for providing program-on-demand in a telecommunications network, the service provider comprising: a web server for receiving a program request for a plurality of selected programs from an SIP terminal; a service application for determining a content provider storing each program of the plurality of selected programs and for establishing an SIP communication session between each content provider storing at least one of the plurality of selected programs and the SIP terminal, the SIP communication session being used for streaming each program of the plurality of selected programs to the SIP terminal from a each content provider

### BRIEF DESCRIPTION OF DRAWINGS

For a more detailed understanding of the invention, for further objects and advantages thereof, reference can now be made to the following description, taken in conjunction with the accompanying drawings, in which:

FIG. 1.a (Prior Art) is a high-level block diagram of a typical prior art scenario for accessing video-on-demand;

FIG. 1.b (Prior Art) is a high-level block diagram of a typical prior art scenario for accessing sound files-on-demand;

FIG. 2 (Prior Art) is a high-level flowchart diagram illustrative of the typical prior art method for accessing program-on-demand;

FIG. 3 is an exemplary high-level network diagram of the preferred embodiment of the present invention;

FIG. 4 is an exemplary nodal operation and message flow diagram illustrative of a preferred embodiment of the present invention;

FIG. 5 is an exemplary nodal operation and message flow diagram illustrative of another preferred embodiment of the present invention;

FIG. 6 is an exemplary nodal operation and message flow diagram illustrative of yet another preferred embodiment of the present invention; and

FIG. 7 is an exemplary illustration of a table of correspondence between a number of programs and their respective locations according to the preferred embodiment of the invention.

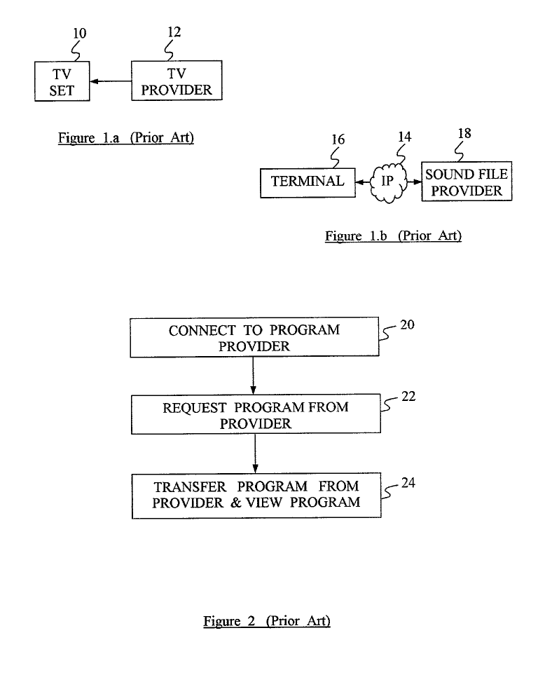

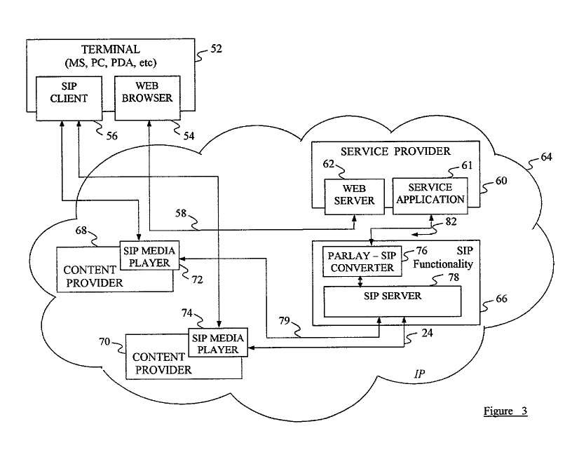

### DETAILED DESCRIPTION

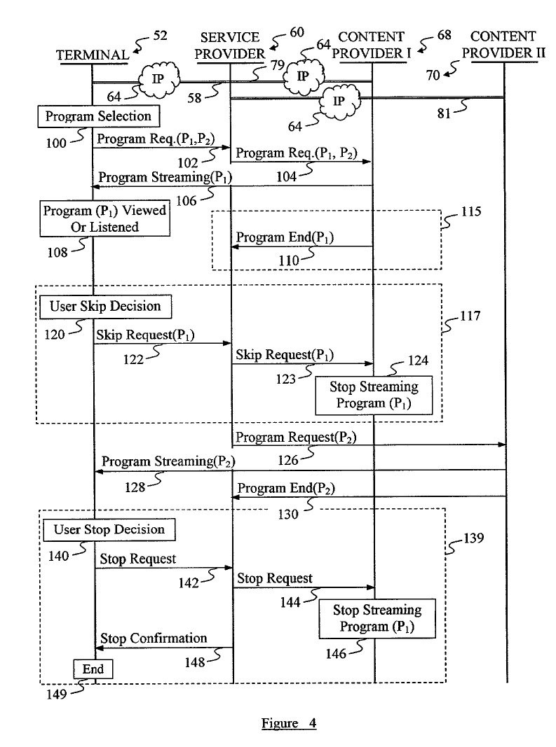

Reference is now made to FIG. 3, which is a high-level network diagram of a system 50 for Internet Protocol (IP) media program transfer-and-viewing-on-demand according to the preferred embodiment of the invention. The system 50 comprises a user terminal 52, such as for example a Mobile Station (MS), a Personal Computer (PC), a Personal Digital Assistant (PDA), or any other type of computer-based device. The user terminal 52 comprises communication means, such as for example a Web browser 54 for accessing the Internet, and a session based client functionality 56 for supporting IP communication and multimedia sessions with other nodes via the Internet. Preferably, the functionality 56 is a Session Initiation Protocol (SIP) client application for supporting SIP communication sessions, and the terminal is an SIP terminal. The terminal 52 is connected through an HTTP link 58 to a service provider 60. The service provider 60 is responsible for controlling the provision of the media programs (songs, movie, shows, news, etc.) to the end-user, and may comprise a Web server 62 for communicating with terminals over the Internet 64.

The service provider 60 further comprises, or is connected to (the later scenario being illustrated in FIG. 3), a session-based protocol functionality 66 supporting a session-based protocol through which the service provider 60 communicates with one or more content providers 68 and 70. For example, the functionality 66 may be an SIP functionality handling SIP communications between content providers and terminals, such as terminal 52, on behalf of the service provider 60. The content providers 68 and 70 are responsible for the storing and the actual provision of the media programs to the end-user terminal 52, and may be operated by the same company that operates the service provider 60, or by third party content provider companies. The content providers communicate with the service provider 60 and the terminal 52 through their respective session based protocol media players 72 and 74 responsible for the streaming of the media programs to the terminal 52, which streaming is preferably achieved through the use of Real-Time Protocol (RTP). Furthermore, the session based protocol media players 72 and 74 are preferably SIP media players supporting SIP session communications.

Although according to the present invention any type of session based protocol can be used for interfacing the content providers 68 and 70 with the service provider 60 and the terminal 52, such as for example H.323, preferably the Session Initiation Protocol (SIP) is utilized. SIP is an Internet Engineering Task Force (IETF) standard protocol for initiating an interactive user session that involves multimedia elements such as video, voice, chat, gaming, and virtual reality. Like HTTP or SMTP (Simple Mail Transfer Protocol), SIP works in the Application layer of the Open Systems Interconnection (OSI) communications model. SIP can establish multimedia sessions or Internet telephony calls, and can modify, or terminate them. The protocol can also invite participants to unicast or multicast sessions that do not necessarily involve the initiator. Because the SIP supports name mapping and redirection services, it makes it possible for users to initiate and receive communications and services from any location, and for networks to identify the users wherever they are. SIP is a request-response protocol, dealing with requests from clients and responses from servers. Participants are identified by SIP URLs (Uniform Resource Locator). Requests can be sent through any transport protocol, such as UDP (User Datagram Protocol), SCTP (Simple Control Transport Protocol), or TCP (Transfer Control Protocol). SIP determines the end system to be used for the session, the communication media and media parameters, and the called party's desire to engage in the communication. Once these are assured, SIP establishes call parameters at either end of the communication, and handles call transfer and termination. The Session Initiation Protocol is specified in IETF Request for Comments [RFC] 2543, herein included by reference.

In a further embodiment of the present invention, the service provider 60 also comprises a service application 61 that may have the form of a service servlet, responsible for handling the communication with the content providers 68 and 70. According to this variant of the invention, the service application 61 of the service provider 60 communicates with the session-based protocol functionality 66 via Parlay/OSA-based messages, according, for example, to the Parlay Specification V2.1 by the Parlay Group, published in June/July 2000, herein included by reference, or to the Third Generation Partnership Project's (3GPP) equivalent Open Service Access (OSA) TS 23.127 v3.3.0 (Rel. 99) or TS 29.198 v3.2.0 (Rel. 99), published between December 1999 and June 2000, herein included by reference. Therefore, the appellation Parlay/OSA, Parlay and OSA is used herein without any limitation as referring to any one of the above-mentioned protocols or specifications.

The SIP functionality 66 comprises a Parlay/SIP converter 76 responsible for transforming the Parlay/OSA messages generated by a service application 61 of the service provider 60, into SIP protocol messages, and vice-versa. In some implementations, the SIP functionality 66 may further comprise a SIP server 78 responsible for the physical and logical interface with the content providers 70 and 68. Parlay/OSA is an umbrella architecture which provides network independence and application portability. Parlay/OSA APIs (Application Program Interfaces) enable a new generation of off-the-shelf network applications/components (e.g. messaging, mobility, end-to-end quality of service, etc.) to be developed by application providers (Independent Software Vendors (ISVS) and Application Service Providers (ASP)) independent of the underlying voice/multimedia network. For example, Parlay/OSA APIs can be implemented on multiple technologies and platforms such as Windows NT™, JAVA VM™, UNIX™, etc. since they are platform, vendor- and technology-independent, allowing for implementation on multiple technologies, and to work easily with other industry initiatives.

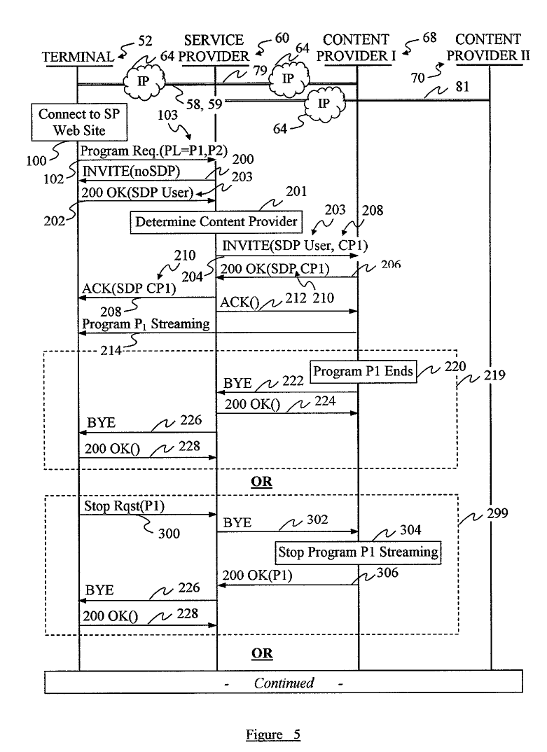

Reference is now made jointly to the previously described FIG. 3, and to FIG. 4 representing an exemplary high-level nodal operation and signal flow diagram of a preferred embodiment of the invention related to the operation of the network described with reference to FIG. 3. In FIG. 4, terminal 52 is preferably connected to the service provider 60 through an HTTP interface 58 over the Internet 64. Likewise, the service provider 60 is connected to content providers 68 and 70 via a communication link 63 over the Internet 64. Communications between the service provider 60 and content providers 68 and 70 are performed through SIP communication sessions 79 and 81 respectively, over the Internet 64.

According to a preferred embodiment of the invention, the user first chooses one or more programs, such as for example programs P1 and P2, to be viewed or listened, action 100, and a program request identifying programs P1 and P2 is sent via the HTTP link 58 to the service provider 60, action 102. The service provider 60 transmits to the appropriate content provider, e.g. to content provider 68, the request for the selected programs P1 and P2, action 104. Upon receipt of request 104, the content provider 68 starts streaming the first selected program P1 toward the terminal 52, using RTP protocol, action 106, and the program P1 is received and executed (viewed or listened to) on terminal 52, action 108.

According to the preferred embodiment of the invention, the data streaming of the selected program can be ended in different manners.

According to a first variant of the preferred embodiment of the invention, the selected program P1 can end normally, which scenario is shown in dotted lines 15. When the selected program P1 normally terminates, the content provider 68 sends a media program end message, action 110, to service provider 60 for notifying the service provider of the normal end of the media program P1.

According to a second variant of the preferred embodiment of the invention, the user is allowed to interrupt the data streaming 106 of the media program before its normal end, scenario represented in dotted lines 117. For example, the user can select a series of two programs to be viewed or listened to one after the other, such as programs P1 and P2. The user can proceed as mentioned hereinabove for ordering the data streaming of the programs to the terminal 52. At a given moment, the user decides to skip the first program before its normal termination, action 120, and continue with a viewing of the second selected program. According to this variant of the invention, the terminal 52 (upon user intervention) sends a skip request message directed to program P1 to the service provider 60, action 122. Upon receipt of message 122, service provider 60 sends a skip program message to content provider 68 requesting the content providers 68 to stop streaming the media program P1. As a consequence, in step 124, content provider 68 stops streaming program P1 to the terminal 52.

Following one of the scenarios 115 or 117 through which the data streaming of program P1 is terminated, the service provider 60 initiates the transmission of the second selected program P2 to user terminal 52. Service provider 60 transmits a program request for program P2 to the appropriate content provider, e.g. to content provider 70, for requesting the beginning of the streaming of the second selected program P2, action 126. In action 128, the content provider 70 begins the streaming of the second selected program P2 to the terminal 52. At the normal end of the program P2, content provider 70 notifies the service provider 60 of the normal termination of program P2, action 130.

According to a third variant of the preferred embodiment of the invention, the user of terminal 52 is allowed to simply stop the streaming of the current program (P1) or series of programs (P1 and P2), scenario shown in dotted lines 139. In step 140, the user decides to stop the streaming of the current program(s), and sends a stop message to service provider 60, action 142. Upon receipt of message 142, the service provider 60 transmits a stop message to the appropriate content provider, e.g. to content provider 68, action 144, which in turn stops streaming the selected program P1, action 146. The service provider 60 finally notifies terminal 52 and the user with confirmation that the streaming of the selected program is stopped, action 148. In this scenario the streaming of the next selected program, i.e. of program P2 is not commenced following the stop of program P1, and the data streaming ends completely at 149.

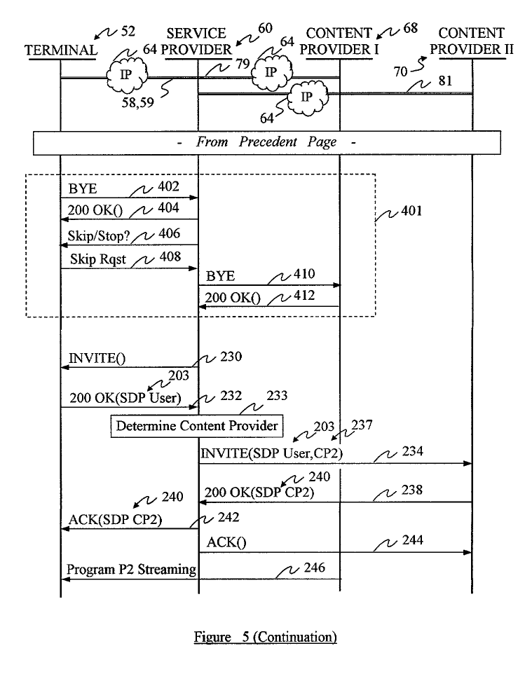

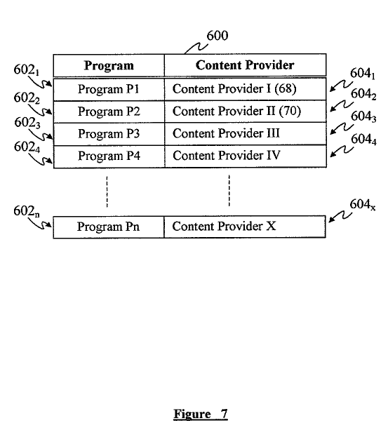

Reference is now made jointly to FIG. 3, previously described, and to FIG. 5 showing an exemplary high-level nodal operation and message flow diagram of the preferred embodiment of the invention. In FIG. 5, terminal 52 is an SIP terminal and communicates with service provider 60 over the Internet 64, preferably using an HTTP connection 58 and SIP connection 59. Service provider 60 communicates over Internet 64 with one or more content providers, such as for example with content providers 68 and 70, using SIP-based connections 79 and 81. First, the user connects SIP terminal 52 to service provider 60″s web server 62, and selects one or more programs to be downloaded and executed (viewed or listened to) on SIP terminal 52, action 100. In action 102 a program request message is sent to service provider 60, the program request preferably comprising a Program List (PL) 103 indicative of the sequence of one or more programs (e.g. two programs P1 and P2) selected by the user. The program request 102 may also be a selection of programs made directly on a web page of the web server 62 of the service provider 60. Upon receipt of the program request from terminal 52, the service provider 60 determines which content provider stores the first program P1 of the program list PL 103, action 201. For that purpose, service provider 60 may comprise a program table 600, as shown in FIG. 7, the program table 600 associating each one of the programs 602ᵢ offered to users (such as Programs P1, P2, etc), with its proper location, i.e. which one of the content providers 604ᵢ (such as content providers 68 or 70) stores that given program. For the purpose of the present example, it is assumed that the service provider 60 determines in action 201 that content provider 68 stores the first selected program P1, as shown in FIG. 7. The service provider 60 then begins the establishment of an SIP session between the user's SIP terminal 52 and the content provider 68 by sending an INVITE message to terminal 52, action 200, which responds with a 200 OK reply message, action 202, wherein the 200 Ok message may comprise the Session Description Protocol (SDP) User 203 identifying the user's terminal 52 preferred communications parameters, such as for example but not limited to the type of the media (e.g. video, audio, etc) and the required codec. Likewise, service provider 60 transmits an INVITE message to content provider 68, the message comprising preferably the SDP User 203 along with the identification of the selected program P1205, action 204. Content provider 68 responds with a 200 OK reply message that may comprise the SDP of Content Provider 68 CP1 210, action 206, for confirming the expected streaming of program P1. The SDP C1 210 is representative of the content provider 68 preferred communications parameters for the requested type of media, and typically is set to match those of the terminal 52. Acknowledgment messages confirming the establishment of the SIP session between content provider 68 and terminal 52 are then sent by the service provider 60 to both parties, action 208 (the message comprising also confirmation of the SDP CP1 210) and action 212. If the SDP CP1 210 does not match the SDP User 203, session negotiation described in 202-208 is redone with a different SDP User 203 and/or SDP CP1 210, until common communications parameters are found. In action 214, the content provider 68 begins streaming the data of the first selected program P1 to terminal 52, preferably using RTP (real-time protocol) over the SIP session.

According to the preferred embodiment of the invention, the program data streaming can end in different manners.

According to a first variant of the preferred embodiment of the invention, shown in dotted lines 219 in FIG. 5, when the selected program normally terminates, action 220 (such as for example when a movie data streaming terminates at the end of the program), the content provider 68 terminates the SIP session by sending a BYE message to the service provider 60, action 222, which replies back with a 200 OK reply message, action 224, for confirming the end of the SIP session involving the content provider 68. Likewise, service provider 60 sends a BYE message to user 52, action 226, and receives back a 200 OK reply message, action 228, confirming the end of the SIP session involving terminal 52. At this point the SIP session that served for the data streaming of program P1 from the content provider to terminal 52 is completely terminated.

According to second variant of the preferred embodiment of the invention, shown in dotted lines 299 in FIG. 5, the user is allowed to stop the currently streamed program P1 and, optionally, go to the next selected program from the program list 103, by using the web page of service provider 60. For example, a user can get uninterested in a poorly acted movie (program P1), desire to end the viewing of the movie and, optionally, go to the following one. In such an instance, the user notifies the service provider 60, through the HTTP link 58 and the web server 62 of the service provider 60, that current program P1 should be terminated, by sending a Stop Request message 300 that may comprise the identification of program P1 to be stopped. Service provider 60 further sends a BYE message 302 to content provider 68 streaming the current program P1, which in turn stops streaming the program P1, action 304, and confirms stopping the program data transmission through a 200 OK message to service provider 60, action 306. Service provider 60 further sends a BYE message 226 to user terminal 52, which responds with a 200 OK reply message 228 confirming the termination of the current SIP session. At this point the SIP session that served for the data streaming of program P1 from the content provider to terminal 52 is completely terminated.

According to a third variant of the preferred embodiment of the invention, shown in dotted lines 401 in FIG. 5, the user can avoid the use of the web server 62 of service provider 60, and terminate the currently running SIP session using SIP-based commands. For terminating the current SIP session, the user sends from terminal 52 to service provider 60 a BYE message, action 402, and receives back a confirmation in the form of a 200 OK reply message, action 404. Service provider 60 may then asks the user whether he/she desires to skip or to stop the currently running program, action 406. Upon the response from the user stating that the desired action is to skip the program action 408, service provider 60 sends a BYE message to content provider 68 running the current program, action 410, which responds back with a 200 OK reply message 412. At this point the SIP session used for the data streaming of program P1 is terminated.

According to the invention, if the user responds in action 408 that the intention is to completely stop the programs transmission, then following the termination of the current SIP session in action 412, no further SIP session is established, and all data transmission ceases.

The data streaming of the first program P1 being now terminated through one of the scenarios presented in 219, 299 or 401, the service provider 60 then initiates the establishment of a second SIP based session allowing the streaming of the second program P2, selected in the program list 103, to user terminal 52, in a manner analogous to the one previously described. Service provider 60 sends an INVITE message to user terminal 52, action 230, and receives back confirmation through a 200 OK reply message 232, comprising the SDP user 203. In action 233, the service provider 60 determines in which content provider can be found the program P2 by consulting its internal table 600, as shown in FIG. 7. It is assumed that service provider 60 determines in action 233 that program P2 is stored in content provider 70. Next, service provider 60 sends an INVITE message 234 to content provider 70, the INVITE message 234 preferably comprising the SDP User 203, so that content provider 70 is informed of the preferred communications parameters of terminal 52, as well as the identity of requested program P2, 237. Content provider 70 then replies with a 200 OK message 238 comprising the SDP CP2 of the content provider 70. Acknowledgments of the establishment of the SIP session are sent by service provider 60 to both terminal 52 and content provider 70, actions 242 and 244, where the confirmation of the action 242 may comprise the SDP CP2 240. In action 246, the actual streaming of the second selected program P2 begins, preferably using RTP protocol over SIP. The establishment, operation, and termination of SIP session can continue as described previously for as one or more media programs as selected in the program list 103, until all the selected programs (P1, P2, . . . , Pn) of list 103 are transmitted to terminal 52.

According to another preferred embodiment of the present invention, the service provider 60 better shown in FIG. 3, communicates with the content providers 68 and 70 through an SIP functionality 66 comprising first, a Parlay/SIP converter 76, and a SIP server 78. In such an implementation, according to the present invention, the service provider 60 issues Parlay/OSA-based messages for communicating with content providers 68 and 70. The Parlay/OSA-based messages may be generated and sent from the service application 61 of the service provider 60 to the Parlay/SIP converter 76 which functions to convert the Parlay/OSA messages into corresponding SIP messages. These messages are further relayed to the SIP server 78, functioning to control the SIP sessions between terminal 52 and the appropriate content provider according, for example, to the SIP specification Request for Comments [RFC] 2543, by the Internet Engineering Task Force (IETF), herein included by reference. The advantage of having the service provider 60 to use Parlay/OSA messaging while still being able to communicate using SIP messaging with a content provider resides in that Parlay/OSA is a very flexible communication language that can be easily used in telecommunications servers. On the other hand SIP is a flexible session based communication protocol suited for multimedia transfer sessions.

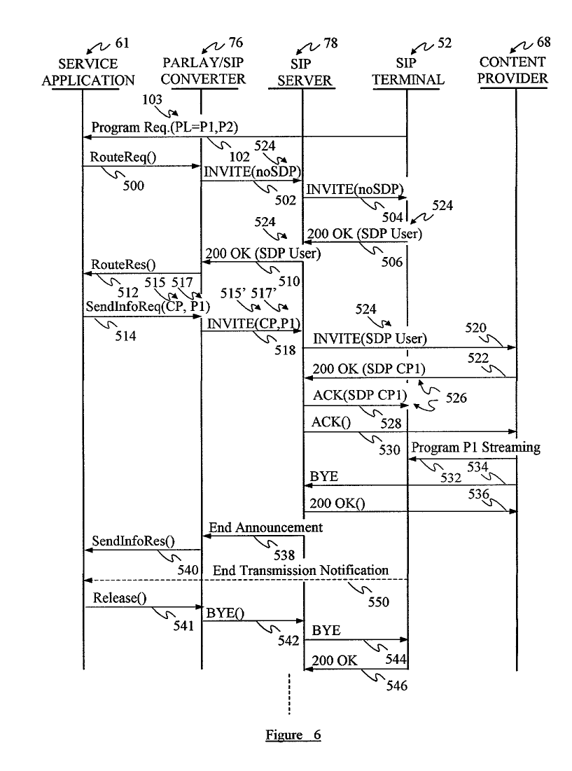

Reference is now further made to FIG. 6 in which there is shown an exemplary high-level nodal operation and signal flow diagram representative of the preferred embodiment of the invention involving both Parlay/OSA and SIP messaging. Represented in FIG. 6 is a service application 61 that can also have the form of a service servlet running an application responsible for managing the interaction of the service provider 60 with content providers, such as with content providers 68 and 70. The service application 61 is capable of receiving, processing and issuing Parlay/OSA based messages for supporting such interaction. Further represented in FIG. 6 is the Parlay/SIP converter 76 responsible for translating Parlay/OSA messages into SIP format, and vice versa. The Parlay/SIP converter 76 may be operated by a telecommunication network operator. The SIP server 78 functions to issue and receive SIP messages on behalf of the service provider 60, to and from the content providers.

In FIG. 6, when the user of the SIP terminal desires to listen to a given series of programs using the SIP terminal, he/she first selects the list of programs. For this purpose, the SIP terminal 52 transmits a program request message 102, comprising a Program List (PL) 103, to the service application 61 of the service provider 60, for requesting the transmission of one or more programs (e.g. P1 and P2) appearing in the program list PL 103. The transmission of the program request 102 between terminal 52 and the service application 61 may be performed over the HTTP link 58 over the Internet 64, as shown in FIG. 3, or through any other link according to a given preferred implementation. The service application 61 then transmits a Parlay/OSA RouteReq( ) message 500 which purpose is to establish a first communication session with terminal 52, which communication session is to be used for streaming the first selected media program from the appropriate content provider to the SIP terminal 52. The Parlay/SIP converter 76 receives the Parlay/OSA RouteReq( ) message 500 and transforms it into an SIP INVITE message 502, which is sent to the SIP server 78. The function of the server 78 is to manage the SIP sessions between the participants in the SIP session. Therefore, responsive to the INVITE message 502, the SIP server 78 transmits an INVITE message 504 to the user terminal 52, which in turn responds with a 200 OK acknowledgment message 506. Preferably, message 506 may also comprises the SDP user 524 as described with reference to FIG. 5. Upon receipt of message 506, the SIP server 78 returns to the Parlay/SIP converter 76 a 200 OK acknowledgment message 510 with the SDP User 524. Upon receipt of the later, the Parlay/SIP converter 76 converts the SIP message 510 into a Parlay/OSA RouteRes( ) confirmation message 512 which is relayed to the service application 61 for informing of the establishment of the first leg of the SIP session, with terminal 52. In action 513, the service application 61 then determines which content provider stores the first selected program P1 and as a result, identifies the content provider 68. It then sends a SendInfoReq( ) message 514, preferably comprising the content provider 68 identity (CP) 515 indicative of the content provider to be contacted for the transmission of the selected program P1, as well as a program identification P1 517 indicative of the selected program P1 from the content provider CP 68. The SendInfoReq( ) message 514 is sent to the Parlay/SIP converter 76, which upon receipt of the message 514, performs a conversion of it into an SIP INVITE message 518 transmitted to the SIP server 78, with similar parameters 515″ and 517″. The server 78 functions to transmit an INVITE message 520 to the content provider 68, preferably along with the SDP User 524. Content provider 68 responds back with a 200 OK acknowledgment message 522 preferably comprising the SDP 526 of the content provider (CP1) 68 indicative of the preferred communications parameters of the content provider 68 for the transmission of program P1. The SIP server 78 then transmits an acknowledgment message 528, comprising the SDP CP1 526 to the SIP terminal 52, for informing terminal 52 of the full establishment of the SIP session between the terminal and the content providers 68. Likewise, the server 78 may also send a second acknowledgment message 530 to the content providers 68 for informing of the full establishment of the SIP session with the terminal 52. Following the full establishment of the SIP session between the SIP terminal 52 and the content provider 68, in action 532 the content provider 68 streams the media program P1 to the user terminal 52 until the end of the program P1. Once the transmission of the program is terminated, the content provider 68 sends a BYE message 534 for terminating the SIP session with the SIP server 78, to which the server 78 responds with a 200 OK acknowledgment message 536. The server 78 also informs the service application 61 of the termination of the SIP session, by sending an announcement message 538 to the Parlay/SIP converter 76, which upon receipt of message 538 converts it into a Parlay/OSA SendInfoReq( ) message 540 transmitted to the service application 61. The service application 61 then sends a Parlay/OSA Release( ) message 541 to the Parlay/SIP converter 76, which converts message 541 into a BYE message 542 sent to the server 78. Upon receipt of message 542, the server 78 releases the SIP session leg with user terminal 52 by issuing a BYE message 544 to terminal 52, which in turn responds with a 200 OK confirmation message 546, transmitted to the server 78 for confirming the end of the SIP session.

It is to be noted by those skilled in the art that the user of terminal 52 is also allowed to close the transmission of the media program before it is normal end, such as for example by transmitting a close transmission notification 550 over the HTTP link with the service application 61. In such a scenario, this notification 550 triggers the release of the leg of the SIP session with the user terminal 52, previously described with reference to messages 541-546, and of the leg of the SIP session with the content provider, similar to the scheme shown in messages 534-536, except that in the present case the BYE message 534 is be sent from the server 78 to the content provider 68, and the 200 OK message 536 is sent from the content provider to the server 78. Furthermore, in instances as those described in relation to FIG. 4 and FIG. 5 wherein more than one program is selected in the program list PL 103, the application server 61 may further initiates the establishment of at least another SIP session to allow transmission of the next program, such as program P2 of list PL 103, from the appropriate content provider to the terminal 52, in a manner analogous to the one described in FIG. 6, actions 500-540. Combinations of messaging schemes described in relation with Fig. S and FIG. 6 are therefore understood to be possible without any limitations and are encompassed by the teaching of the present invention.

It is also understood that the SIP terminal 52 can be any kind of wireless of wireline terminal that is supportive of SIP-based communications sessions, including a type of terminal supportive of other type of communications.

In a variant of the preferred embodiment of the invention, the Parlay/SIP converter 76 may be i) a Parlay Gateway or ii) an OSA Service Capability Server (SCS), and may be either co-located with the SIP server 78, or placed at a different location than the SIP server 78. Therefore, it is understood that although the appellation Parlay/SIP converter is utilized herein, the Parlay/SIP converter can perform various actions and have in addition different functions than only Parlay(OSA) to and from SIP messaging conversions. Furthermore, in a 3GPP network, the SIP server 78 shown in the various Figures, may be a Call State Control Function (CSCF).

Although al preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. In a telecommunications network comprising a program service provider connected to a plurality of program content provider, a method of performing program-on-demand from a Session Initiation Protocol (SIP) terminal, the method comprising the steps of:
a) sending a program request to the service provider, the program request comprising a program list including a plurality of selected programs;
b) responsive to a receipt of the program request, determining in the service provider a content provider storing a first program (P1) from the plurality of selected programs;
c) the service provider establishing a first SIP session between the SIP terminal and the content provider storing the first program P1; and
d) streaming from the content provider storing the first program P1 to the SIP terminal the first program P1 over the first SIP session.

2. The method claimed in claim 1, further comprising the steps of:
e) releasing the first SIP session between the SIP terminal and the content provider storing the first program P1;
f) following the release of the first SIP session, determining in the service provider a content provider storing a second program (P2) from the plurality of selected programs;
g) the service provider establishing a second SIP session between the SIP terminal and the content provider storing the second program P2; and h) streaming from the content provider storing the second program P2 to the SIP terminal the second program P2 over the second SIP session.

3. The method claimed in claim 1, wherein step c) comprises the steps of:
i) sending a first INVITE message from the service provider to the SIP terminal for establishing a first leg of the first SIP session; and
j) sending a second INVITE message from the service provider to the content provider storing the first program P1 for establishing a second leg of the first SIP session.

4. The method claimed in claim 3, wherein the service provider is connected to an SIP functionality having a Parlay/SIP converter and an SIP server, and wherein the method comprises previous to step i) the steps of:
sending a Parlay/OSA RouteReq( ) message from a service application of the service provider to the Parlay/SIP converter, the Parlay/OSA RouteReq( ) message being indicative of a request for the establishment of the first leg of the first SIP session; and
upon receipt of the Parlay/OSA RouteReq( ) message, the Parlay/SIP converter converting the Parlay/OSA RouteReq( ) message into the first INVITE message; and the Parlay/SIP converter sending the first INVITE message to the SIP server;
wherein the step i) of sending the first INVITE message from the service provider to the SIP terminal includes sending the first INVITE message from the SIP server to the SIP terminal.

5. The method claimed in claim 4, wherein the method comprises previous to step j) the steps of:
sending a Parlay/OSA SendInfoReq( ) message from the service application to the Parlay/SIP converter, the Parlay/OSA SendInfoReq( ) message being indicative of a request for the establishment of the second leg of the first SIP session; and
upon receipt of the Parlay/OSA SendInfoReq( ) message, the Parlay/SIP converter converting the Parlay/OSA SendInfoReq( ) message into the second INVITE message; and
the Parlay/SIP converter sending the second INVITE message to the SIP server;
wherein the step j) of sending the second INVITE message from the service provider to the SIP terminal includes sending the second INVITE message from the SIP server to the SIP terminal.

6. The method claimed in claim 1, wherein the step a) of sending a program request is performed over an HTTP (Hyper Text Transfer Protocol) link over the Internet connecting the SIP terminal and the service provider.

7. The method claimed in claim 1, wherein the step d) of streaming the first program P1 comprises the step of:
streaming a program data of the first program P1 from the content provider to the SIP terminal using a Real-Time Protocol (RTP) over the first SIP session.

8. The method claimed in claim 2, wherein the step e) of releasing the first SIP session between the SIP terminal and the content provider storing the first program P1 is performed following a termination of the first program P1.

9. The method claimed in claim 2, wherein the step e) of releasing the first SIP session between the SIP terminal and the content provider storing the first program P1 is performed responsive to a stop request message sent from the SIP terminal to the service provider for stopping the streaming of the first program P1.

10. The method claimed in claim 2, wherein the step e) of releasing the first SIP session between the SIP terminal and the content provider storing the first program P1 is performed responsive to a skip request message sent from the SIP terminal to the service provider for skipping the streaming of the first program P1.

11. A telecommunications network comprising:
an SIP terminal;
a program service provider connected to the SIP terminal through a communications interface;
a plurality of programs content providers connected to the service provider;
wherein the SIP terminal sends to the service provider a program request comprising a program list including a plurality of selected programs, the service provider determines a content provider storing a first program (P1) from the plurality of selected programs and establishes a first SIP session between the SIP terminal and the content provider, the content provider streaming the first program P1 to the SIP terminal over the first SIP session.

12. The telecommunications network claimed in claim 11, wherein:
the service provider releases the first SIP session between the SIP terminal and the content provider storing the first program P1;
following the release of the first SIP session, the service provider determines a content provider storing a second program (P2) from the plurality of selected programs;
the service provider establishes a second SIP session between the SIP terminal and the content provider storing the second program P2; and the content provider storing the second program P2 streams to the SIP terminal the second program P2 over the second SIP session.

13. The telecommunications network claimed in claim 11, wherein:
the service provider sends a first INVITE message to the SIP terminal for establishing a first leg of the first SIP session; and
the service provider sending a second INVITE message to the content provider storing the first program P1 for establishing a second leg of the first SIP session.

14. The telecommunications network claimed in claim 13, further comprising:
an SIP functionality having a Parlay/SIP converter and a SIP server, the SIP functionality being connected to the service provider;
wherein the service provider further includes a service application sending a Parlay/OSA RouteReq( ) message to the Parlay/SIP converter, the Parlay/OSA RouteReq( ) message being indicative of a request for the establishment of the first leg of the first SIP session, wherein upon receipt of the Parlay/OSA RouteReq( ) message, the Parlay/SIP converter converts the Parlay/OSA RouteReq( ) message into the first INVITE message, and the Parlay/SIP converter sends the first INVITE message to the SIP server, and wherein the first INVITE message is sent to the SIP terminal from the SIP server.

15. The telecommunications network claimed in claim 14, wherein:
the service application sends a Parlay/OSA SendInfoReq( ) message to the Parlay/SIP converter, the Parlay/OSA SendInfoReq( ) message being indicative of a request for the establishment of the second leg of the first SIP session;
upon receipt of the Parlay/OSA SendInfoReq( ) message, the Parlay/SIP converter converts the Parlay/OSA SendInfoReq( ) message into the second INVITE message; and
the Parlay/SIP converter sends the second INVITE message to the SIP server;
wherein the SIP server sends the second INVITE message to the SIP terminal.

16. The telecommunications network claimed in claim 11, further comprising:
an HTTP (Hyper Text Transfer Protocol) link over the Internet connecting the SIP terminal and the service provider, wherein the SIP terminal sends the program request to the service provider over the HTTP link.

17. The telecommunications network claimed in claim 11, wherein the content provider streams a program data of the first program P1 to the SIP terminal using a Real-Time Protocol (RTP) over the first SIP session.

18. The telecommunications network claimed in claim 12, wherein releasing the first SIP session between the SIP terminal and the content provider storing the first program P1 is performed following a termination of the first program P1.

19. The telecommunications network claimed in claim 12, wherein releasing the first SIP session between the SIP terminal and the content provider storing the first program P1 is performed responsive to a stop request message sent from the SIP terminal to the service provider for stopping the streaming of the first program P1.

20. The telecommunications network claimed in claim 12, wherein the releasing the first SIP session between the SIP terminal and the content provider storing the first program P1 is performed responsive to a skip request message sent from the SIP terminal to the service provider for skipping the streaming of the first program P1.

21. The telecommunications network claimed in claim 11, wherein the content provider storing the first program P1 comprises a Program Media Player for streaming a program data of the first selected program P1 to the terminal using a Real-Time Protocol (RTP) over the first SIP session, following the establishment of the first SIP session.

22. A service provider for providing program-on-demand in a telecommunications network, the service provider comprising:
a web server for receiving a program request for a plurality of selected programs from an SIP terminal;
a service application for determining a content provider storing each program of the plurality of selected programs and for establishing an SIP communication session between each content provider storing at least one of the plurality of selected programs and the SIP terminal, the SIP communication session being used for streaming each program of the plurality of selected programs to the SIP terminal from a each content provider.

23. The service provider claimed in claim 22, wherein the service application functions to issue Parlay/OSA messages for the establishment of the SIP communication session, and the service provider is further connected to:
a Parlay/SIP (Session Initiation Protocol) converter for converting the Parlay/OSA messages into SIP messages; and
a SIP server for handling an establishment of the SIP communication session.

24. The service provider claimed in claim 22, wherein the program request is received through an HTTP (Hyper Text Transfer Protocol) link over the Internet connection the terminal to the web server of the service provider.
